(19) United States
(12) Patent Application Publication
(10) Pub. No.: US 2020/0269320 A1
(43) Pub. Date: Aug. 27, 2020

(54) MOLDING METHOD AND APPARATUS, PARTICULARLY APPLICABLE TO METAL AND/OR CERAMICS

(71) Applicant: Tritone Technologies Ltd., Petach Tikva (IL)

(72) Inventors: Ofer BEN-ZUR, Hod-HaSharon (IL); Hagai PELED, Tel-Aviv (IL)

(73) Assignee: Tritone Technologies Ltd., Petach Tikva (IL)

(21) Appl. No.: 16/605,241

(22) PCT Filed: Apr. 30, 2018
(86) PCT No.: PCT/IL2018/050475

§ 371 Date: Oct. 15, 2019

Related U.S. Application Data
(60) Provisional application No. 62/492,305, filed on May 1, 2017.

(51) Int. Cl. B22F 7/02; B22F 3/15; B22F 3/22; B33Y 10/00; B33Y 80/00; B22C 9/02

(52) U.S. Cl. CPC B22F 7/02; B22F 3/15; B22C 9/02; B33Y 10/00; B33Y 80/00; B22F 3/225

(57) ABSTRACT

Method and apparatus for manufacturing a molded layered product comprises: printing a first mold to define one layer of the product; filling the first mold with a cast material, thereby forming a first layer; printing a second mold on top of the first layer to define a second layer; and filling the second mold, over the first layer, with a cast material. The cast material may be a paste. The alternative mold printing and casting are continued until a molded layered product or part product is formed.

### FIELD AND BACKGROUND OF THE INVENTION

The present invention, in some embodiments thereof, relates to a process and an apparatus for additive manufacturing of metal and ceramic parts.

Additive Manufacturing, or 3D printing, is widely used today to make prototype parts and for small-scale manufacturing. A widely used technique is fused deposition modeling (FDM) in which a plastic filament is unwound from a coil, fused and passed through a nozzle to be laid down as flattened strings to form layers from which a 3D object eventually emerges.

Another technique that is used is stereolithography. Stereolithography is an additive manufacturing process that works by focusing an ultraviolet (UV) laser on to a vat of photopolymer resin. With the help of computer aided manufacturing or computer aided design software (CAM/CAD), the UV laser is used to draw a pre-programmed design or shape on to the surface of the photopolymer vat. Because photopolymers are photosensitive under ultraviolet light, the resin is solidified and forms a single layer of the desired 3D object. The process is repeated for each layer of the design until the 3D object is complete.

Selective Laser Sintering SLS is another additive manufacturing layer technology, and involves the use of a high power laser, for example, a carbon dioxide laser, to fuse small particles of plastic into a mass that has a desired three-dimensional shape. The laser selectively fuses powdered material by scanning cross-sections generated from a 3-D digital description of the part (for example from a CAD file or scan data) on the surface of a powder bed. After each cross-section is scanned, the powder bed is lowered by one layer thickness, a new layer of material is applied on top, and the process is repeated until the part is completed.

Due to their relatively high melting temperatures, metal and ceramic materials are more difficult to use in additive manufacturing procedures.

Additive Manufacturing technologies are in general slow compared to conventional production processes such as machining etc. due to the building process of forming the part layer by layer.

A metal printing technique which is widely used is the DMLS—Direct Metal Sintering Laser. A very thin layer of metal powder is spread across the surface that is to be printed. A laser is slowly and steadily moved across the surface to sinter the powder, Additional layers of powder are then applied and sintered, thus “printing” the object one cross-section at a time. In this way, DMLS gradually builds up a 3D object through a series of very thin layers.

Another method of 3D metal printing is selective laser melting (SLM), in which a high-powered laser fully melts each layer of metal powder rather than just sintering it. Selective laser melting produces printed objects that are extremely dense and strong. Selective laser melting can only be used with certain metals. The technique can be used for the additive manufacturing of stainless steel, tool steel, titanium, cobalt chrome and aluminum parts. Selective laser melting is a very high-energy process, as each layer of metal powder must be heated above the melting point of the metal. The high temperature gradients that occur during SLM manufacturing can also lead to stresses and dislocations inside the final product, which can compromise its physical properties.

Electron beam melting (EBM) is an additive manufacturing process that is very similar to selective laser melting. Like SLM, it produces models that are very dense. The difference between the two techniques is that EBM uses an electron beam rather than a laser to melt the metal powder. Currently, electron beam melting can only be used with a limited number of metals. Titanium alloys are the main starting material for this process, although cobalt chrome can also be used.

The above-described metal printing technologies are expensive, very slow, and limited by build size and materials that can be used.

Binder Jet 3D-Printing is widely used to print sand molds for castings or to generate complex ceramic parts. It is also known as a Metal Additive Manufacturing technology. Instead of melting the material, as is done in Selective Laser Melting (SLM) or Electron Beam Melting (EBM), the metal powders are selectively joined by an adhesive ink and afterwards partially sintered and infiltrated.

Metal Binder Jet technology is in some cases, limited to composite Metal alloys, particularly for Stainless Steel—Bronze compositions.

A technique for printing of ceramics is disclosed in Ceramics 3D Printing by Selective Inhibition Sintering—Khoshnevis et al., in which, as with metal, an inhibition material forms a boundary defining edges around a ceramic powder layer which is then sintered. The inhibition layer is subsequently removed.

US Patent Publication No. 2014/0339745A1 to Stuart Uram, discloses a method of making an object using mold casting comprising applying a slip mixture into a mold fabricated using Additive Manufacturing and then firing the mold with the mixture inside. The disclosure discusses a composition of 10-60% by weight of calcium aluminate and a filler.

Rapid Prototyping and manufacturing by gelcasting of metallic and ceramic slurries, Stampfl et al., Materials Science and Engineering A334 (2002) 187-192 discloses using Additive Manufacturing to make a wax mold and then introducing a slurry containing the final part material in powdered form.

Powder Injection Molding (PIM) is a conventional process by which finely-powdered metal (in MIM—Metal Injection Molding) or ceramic (in CIM—Ceramic Injection Molding) is mixed with a measured amount of binder material to comprise a feedstock capable of being handled by injection molding. The molding process allows dilated complex parts, which are oversized due to the presence of binder agent in the feedstock, to be shaped in a single step and in high volume. After molding, the powder-binder mixture is subjected to debinding steps that remove the binder, and sintering, to densify the powders. End products are small components used in various industries and applications. The nature of the PIM feedstock flow is defined using rheology. Current equipment capability requires processing to stay limited to products that can be molded using typical volumes of 100 grams or less per shot into the mold. The variety of materials capable of implementation within PIM feedstock are broad. Subsequent conditioning operations are performed on the molded shape, where the binder material is removed and the metal or ceramic particles are diffusion bonded and densified into the desired state with typically 15% shrinkage in each dimension. Since PIM parts are made in precision injection molds, similar to those used with plastic, the tooling can be quite expensive. As a result, PIM is usually used only for higher-volume parts.

It is desirable inter alia to find an efficient way of carrying out Additive Manufacturing using ceramics and metals that is relatively fast, capable of creating complex geometries and compatible with a large variety of materials.

### SUMMARY OF THE INVENTION

The present embodiments relate to combining Additive Manufacturing with molding techniques in order to build shapes that have hitherto not been possible with conventional molding or machining technologies or in order to use materials that are difficult or impossible to use with known Additive Manufacturing technologies, or to build shapes faster than is possible with known Additive Manufacturing technologies.

In embodiments, Additive Manufacturing is used to make a mold and then the mold is filled with the material of the final product. In some embodiments, layers of the final product are separately constructed with individual molds, where a subsequent layer is made over a previous layer. The previous layer may in fact support the mold of the new layer, as well as provide the floor for the new layer.

In one embodiment, a printing unit is provided which has a first nozzle for 3D printing material to form the mold, and a second, separate, nozzle to provide the filler. The second nozzle may be adjusted to provide different size openings to fill different sized molds efficiently. In other embodiments two separate applicators are provided, one for printing the mold and having three degrees of freedom as needed for 3D printing, and one for filling the mold after it has been formed.

One embodiment comprises the use of inkjet print heads to print the mold using wax or any other hot melt or thermo-set or UV cured material, and the possibility to level the paste cast deposited layer by use of a self-leveling cast material. An alternative for leveling the cast is by vibrating the cast material just after molding, and a further alternative comprises using mechanical tools such as squeegee or blade and to fill and level the mold.

According to an aspect of some embodiments of the present invention there is provided a method of manufacturing a molded layered product comprising:

printing a first mold to define one layer of the product;

filling the first mold with a cast material, thereby forming a first layer;

printing a second mold on top of the first layer to define a second layer; and

filling the second layer, over the first layer, with a cast material; thereby to form a molded layered product.

The method may comprise finishing the first layer after forming and prior to printing the second mold; thereby to form the second layer on the finished surface of the first layer. Finishing refers to drying or hardening the layer and then smoothing or cutting the layer surface to remove excess material, such as excess paste, from over the mold.

In an embodiment, the molds are printed using a mold printing material.

In an embodiment, the mold printing material has a melting point which is lower than a melting point of the cast material.

In an embodiment, the cast material comprises any of wax, binders, hardening materials, a dispersing agent, an antifoam agent, a monomer, an oligomer, an initiator, an activator, a stabilizer, a debinding control additive, and a sintering controlling agent and either of a ceramic and a metal.

In an embodiment, the mold cast material comprises a slip material, or a gelcast material or a paste material.

In an embodiment, the mold printing material comprises a viscosity which is higher than a viscosity of the cast material.

In an embodiment, the slip or paste is a water based or organic solvent based material, and may be energy activated material.

In an embodiment, the cast material comprises a hydrophilic or hydrophobic component.

In an embodiment, the filling comprising pouring the cast material into the mold.

In an embodiment, the pouring is from a pouring nozzle.

The method may comprise selecting the pouring nozzle according to a size of a space in the mold to be filled.

In an embodiment, filling involves injection molding of the cast material into the mold. In an embodiment, the filling comprising using a squeegee or blade to spread the cast material into the mold. The present embodiments may use a squeegee or blade that touches the mold surface and grabs or pushes the paste. An alternative is to keep the squeegee or blade slightly above the mold surface and grab the paste without touching the surface.

In an embodiment, two or more different cast materials are used in different layers.

According to a second aspect of the present invention there is provided a 3D printing device for printing a mold and filling the mold comprising:

a first nozzle having a first size, for 3D printing the mold using a first mold material; and

a second nozzle at a second size different from the first size, for pouring material to fill the mold.

According to a third aspect of the present invention there is provided a 3D printing device for printing a mold and filling the mold comprising:

a nozzle, for 3D printing the mold using a mold material; and

a squeegee or blade for pasting filling material to fill the mold.

According to a fourth aspect of the present invention there is provided a 3D printing device for printing a mold and filling the mold comprising:

a nozzle, for 3D printing the mold using a mold material;

a sealing cap for sealing the mold; and

an injection molding unit for injecting filling material to fill the mold.

According to a fifth aspect of the present invention there is provided a method of manufacturing a layered molded product, comprising:

preparing a plan of the layered molded product;

slicing the plan into a plurality of layers;

for each layer planning a mold;

for each layer in succession, 3D printing a respectively planned mold; and

for each layer in succession, after forming the respective mold, pouring a cast material into the mold to form the respective layer; and

3D printing successive layer molds on a respectively preceding layer.

The method may comprise hardening each layer prior to printing a successive layer mold thereon, additionally or alternatively including polishing respective layers prior to forming a subsequent layer thereon.

The cast material may have rheological properties to flow and fill the mold and to hold to an inner surface of the mold.

The method may use heat to stabilize the product after all layers thereof have been formed.

The method may comprise removing respective mold layers.

The method may comprise heating to remove binding or sacrificial material from the cast material.

In an embodiment, the cast material comprises a powder, the method comprising applying thermal treatment to sinter the powder. A Hot Isostatic Pressing process (HIP) may be used to increase a density of the cast material.

According to a sixth aspect of the present invention there is provided a molded part or product made of metal or ceramic according to the above methods.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Operation of the 3D printing device of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified flow chart illustrating a procedure for producing a layered molded product or part according to embodiments of the present invention;

FIG. 1B is a simplified flow chart showing a more detailed embodiment of the procedure of FIG. 1A;

FIG. 2 is a simplified diagram showing a plan for a part to be made using the present embodiments;

FIG. 3 is a simplified diagram showing one exemplary way of slicing the part of FIG. 2 for layered manufacture according to the present embodiments;

FIG. 4 is a simplified diagram showing a printed mold for a first layer to make the part of FIG. 2;

FIG. 5 is a simplified diagram showing casting of the mold made in FIG. 3 in order to form a first layer of the part of FIG. 2;

FIG. 6 is a simplified diagram illustrating printing of the mold for a second layer of the part of FIG. 2;

FIG. 7 is a simplified diagram illustrating casting of the mold made in FIG. 6;

FIG. 8 is a simplified diagram showing the part made according to FIG. 2 after removing of the mold,

FIG. 9 is a simplified diagram of a two station linear device for making layered molded parts or products according to the present embodiments;

FIG. 10 is a variation of the device of FIG. 9 in which the mold printing and pouring applicators are combined into a single operating applicator;

FIG. 11 and FIG. 12 are front view and top view respectively of variation of the device of FIG. 9 having a printing station and a pouring station and two platens, each on a separate track;

FIG. 13 is a variation of the device of FIG. 9 based on a four station carousel;

FIG. 14 is a variation of the device of FIG. 9 further incorporating a surface finishing station using a cylinder which is optionally heated;

FIG. 15 is a variation of the device of FIG. 9 in which a squeegee or blade touches the mold surface and spreads a paste to fill the mold;

FIG. 16 is a variation of the device of FIG. 15 in which a squeegee is raised above the surface of the mould;

FIG. 17 is a variation of the device of FIG. 9 further incorporating a cutter;

FIG. 18 is a variation of the device of FIG. 9 in which injection molding is used to fill a layer mold printed according to the present embodiments; and

FIG. 19 is a flow chart showing a procedure for detecting and correcting a faulty layer according to embodiments of the present invention.

### DESCRIPTION OF SPECIFIC EMBODIMENTS OF THE INVENTION

The present invention, in some embodiments thereof, relates to a process and an apparatus for Additive Manufacturing of metals and ceramics.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

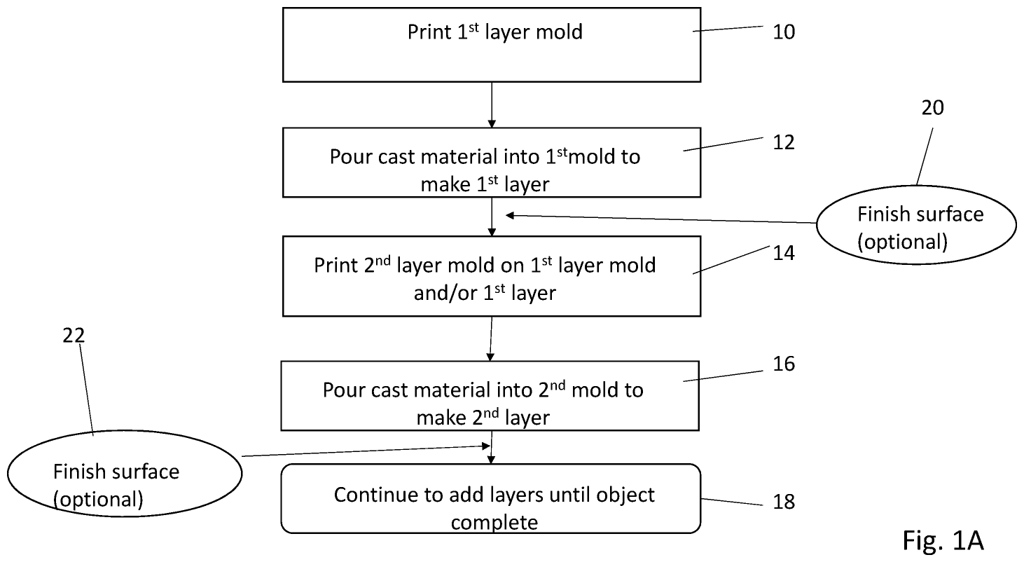

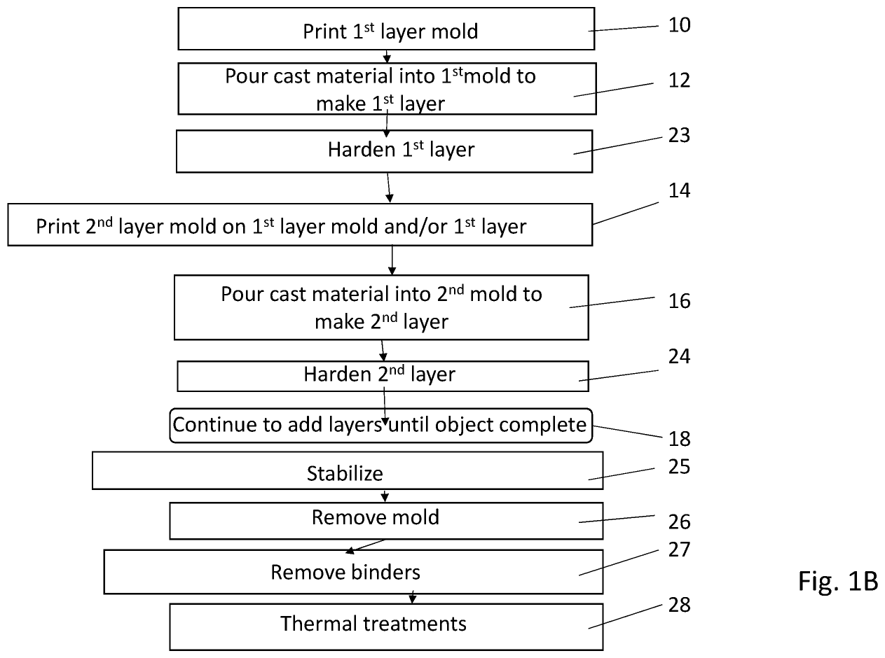

Referring now to the drawings, FIG. 1A is a simplified flow chart showing a method of manufacturing a molded layered product according to the present embodiments. A first box 10 indicates printing a first mold to define one layer of the product. The mold may be printed using known Additive Manufacturing technology, as will be discussed in greater detail hereinbelow. Box 12 indicates pouring a cast material to fill the mold printed in box 10. The cast material may then form a first layer of the eventual molded layered product.

In box 14 a second layer mold is then printed on the first layer and/or on the first molding layer. In some cases the second layer is smaller than the first layer in at least one dimension, so that the second layer mold is deposited on the cast part of the first layer. As will be discussed in greater detail below, the cast layer may be hardened to support the printing, or printing of the second layer mold may wait until the first layer is sufficiently dry, or hardened to support the second layer mold.

In box 16 more cast material is poured into the second layer mold to form the second layer of the product. As shown in box 18, the procedure is repeated as often as necessary to form a molded layered product with the requisite number of layers. It will be appreciated that different layers may be of different thicknesses.

After pouring, the new surfaces of the cast layers may optionally be finished or polished with finishing tools as shown in 20 and 22.

The molds may be printed using any standard mold printing material that is strong enough to hold the casting material at casting temperatures and other casting conditions. Any standard 3D printing technique, such as fused deposition modeling (FDM) or Inkjet printing, may be used to print the mold.

In embodiments, the mold printing material has a melting point temperature which is lower than a melting point of the cast material, so that heating can be used to clean away the mold once the product is ready. For example the mold may use wax and the cast material may be any suitable cast material which has a higher melting point than wax. If sintering is used, then the cast material may be any material that can be sintered, including ceramics, metal and in some cases plastics.

Likewise any material that can be used in its green stage can be used, and such materials are particularly useful for ceramic molds.

In embodiments the tendency may be for the process to heat up beyond a desired temperature. Thus cooling processes may be used, such as using air flow.

The cast material may in general be any material that can fill a mold and which can subsequently be hardened, say by drying or cooling, or by any energy activation transition reaction or sintered to endow the product with the properties needed. Hardening methods may include evaporation or activation reactions including energy curing, say thermosetting, or UV curing and the like. IR, microwave or UV irradiation may be used as well as blowing with hot air

In embodiments the cast material may be a mixture of wax or monomer or oligomer activated to impart hardening or polymer emulsion or dissolved polymers that dry to harden the cast material, and either a ceramic powder or a metal powder or a mix of materials. Thus the layer may be formed of a mixture of materials, say to achieve particular mechanical or other properties. The end product may then be heated to melt the mold material, or may be immersed in solvent to dissolve the mold, and then may be immersed in solvent to leaching out part of the additives and may be heated to a higher temperature to remove the binders and also may be further sintered to fuse the powder and may even be subjected to other common thermal processes such as HIP (Hot Isotropic Pressure) Thus the present embodiments may provide a way to make molded ceramic or metal or compound products.

A slip, slurry or paste mixture is a suspension of ceramic or and metal particles, optionally a mix of a few powders, in a liquid carrier, such as water or an organic solvent such as polyolefine, Alcohol, glycol, polyethyleneglycol, glycol ether, glycol ether acetate and other and the cast material may comprise a mixture, such as a water- or solvent based composition of 60-95% by weight of powder or powder mixture.

Gelcasting is a ceramic forming technology for making complex-shaped ceramic products with high performance. The processes used in gelcasting are similar to processes often used in conventional ceramic forming process but are tailored to achieving high strengths and good mechanical properties. Gelcasting involves using a slurry containing the final part material in powdered form, and involves steps such as removal of internal bubbles, to achieve the target properties.

The paste is a dispersion of powder and organic materials in a liquid, and may have rheological properties to able to flow and fill the mold from one side and to properly lay to the deposited mold materials at the mold interface surface.

In the case of the gelcast hardening process, the cast material has shear thinning and thixotropy to ensure proper flow and to fill the mold. The temperature of the pre-mold and cast materials are low in order to increase the viscosity of the slip and to solidify the hot cast material as soon as it deposited. The cast material is immiscible with mold materials. Embodiments may use a water base slip material with a hydrophobic cast material or vice versa. Some surface wetting properties may be retained for controlling and reproducing small feature sizes.

A mold design approach may allow a decrease in the load of the mold material over the slip cast material. Engineering of the design process may ensure that the weight of the deposited mold materials is divided over an area as large as possible so as to support the structure.

An additional hardening procedure may use an energy activation process i.e. hardening, of the deposited slip which may be achieved by intervention to change the physical conditions such as drying or polymerized transition reaction using means such as: thermo-curing, UV curing.

In embodiments, the mold printing material may have a viscosity which is higher than the viscosity of the cast material, so that the mold remains intact when the cast material is poured in. The cast material may have good wetting to properly fill the mold.

In embodiments, the cast material may have low viscosity at room temperature and good wetting ability of mold material. The cast material may be capable of being hardened after deposition by drying or polymerized transition reaction using means such as: thermo-curing, UV curing. The cast material may also have low shrinkage and good debinding properties.

In embodiments, the cast material may include a hydrophilic or hydrophobic component.

Using gelcast, or drying, or polymerized transition reaction and like processes, a product may be built with strong layered bonding without mechanical or chemical defects.

Casting or pouring may be carried out at an elevated temperature, with tight control of materials to provide the mechanical properties necessary. Pouring may use a liquid dispensing systems that consists of a dispensing control unit. The quantity of filling material may be set according to Sub Mold parameters such as volume, overflow factor, etc. Then the cast material may be leveled by mechanical means such as a squeegee or blade or under its own self leveling property with an optional vibrating procedure.

After pouring, the material may be energy activated by IR to a temperature that produces a more stable state, say a hardened state, say in the range of 30-150° C. Alternatively, the material may be energy activated by UV etc. The Material is thus hardened.

Later on, the Sub Molds, that is the molds of the individual layers, may be removed by exposing the assembly to a higher temperature, or using a chemical dissolving process say with an acid or by immersion in solvent to dissolve the mold material or other processes. Suitable temperatures in the case of a wax based mold may be in the range of 50-250° C.

A debinding and sintering stage may involve increasing the temperature to allow debinding and sintering of the active part of the cast material, and typical temperatures for de binding and sintering are in the range of 200° C.-1800° C. depending on the exact material and required mechanical properties of the final product.

According to a proposed process according to the present embodiments, a paste cast material is cast under high shear force and under controlled temperature. The paste cast material in this embodiment may be deposited over the previous layer of slip cast material that was cast at high viscosity, hardness and may be at a lower temperature.

Since two successive layers are composed of the same material, they may be expected to share properties. In general, casting materials are water or organic solvent based and allow for dispersion of materials.

Drying, debinding and sintering may be carried out in ovens, which may be integrated in a single device or may be provided separately.

A process according to FIG. 1A is now considered in greater detail.

The process may use a cast material and a mold material. The mold material may for example be any material that freezes below 300° C. and has a sharp melting point, such as mineral wax. The molding material may be applied by any controlled additive manufacturing tool such as FDM or Inkjet technology as discussed above, and is therefore selected from materials suitable for such processes.

The cast material may be composed of a functional powder dispersed in sacrificial materials. A cast material paste may be selected that freezes at a lower temperature than the corresponding mold material melting point and the corresponding gel temperature. As an example, mixtures of suitable PEGs etc. may be used as the sacrificial material to arrive at the necessary freezing and melting point combinations. As an alternative, hardening may use a monomer or oligomer that is polymerized by energy activation, by a transition reaction or alternatively involves hardening by drying.

Cast material such as a slurry or paste may be gelled at a temperature higher than the freeze temperature and lower than the mold material melting point. Alternatively, a self-hardening cast material may be used, for example: epoxy low viscosity monomers and or oligomers with suitable hardener and/or acrylic and/or methacrylic monomers with suitable cross linkers.

To ensure the stability of the first layer of cast material such as a slurry or paste, the slurry or paste may be designed to possess rheological properties that cause the still non-flowing material to behave as a hard gel and when needed, to include appropriate shear thinning and thixotropy, so that the viscosity may or may not vary.

The binding materials may include a liquid carrier, that is the flowing part of the slurry or paste and used as a functional hardening agent, and may contain organic additives at a final stage, which may be dried and decomposed at <700° C. so as to be removed when no longer required.

The functional powder is the metal or/and metal oxide or ceramic that makes up the body of the final product. The material may be chosen to be thermally treated at >500° C. to fuse the powder after disappearance of the sacrificial materials to form the final solid body.

Referring now to FIG. 1B, and the process comprises as in box 10, building of the mold, in which 3D printing may use any of: mineral wax at m.p.>60° C. UV/EB cured acrylic, methacrylic, thermally cured epoxy, polyurethane etc., to form the mold parts.

A tray is placed in position and the first layer mold sub part is built on the tray.

The mold is then filled 12 with the cast material in liquid or slurry form or paste form. The cast material may be poured, or may in embodiments be injected, under a high shear force into the mold to ensure intimate contact with the mold walls, thereby to ensure proper and complete filling of the mold. The mold itself may be mechanically strong enough to cope with the injection forces.

The now formed (n−1) sub part or layer provides a base for the next, the n^{th}, sub-part.

Solidifying or hardening 23 the cast material slurry or paste may be needed to render the layer capable of bearing the load of the subsequent layer of mold material. In other cases the viscosity of the layer already formed may be sufficient. Solidifying or hardening may be achieved by using any one or more of the following means:

1. Keeping the temperature of the cast low enough to freeze the slurry or paste already cast from the previous layer.

2: Hardening the cast material slurry or paste using a thermosetting process, for example using epoxy resin and/or acrylic and/or methacrylic crosslinkable monomers.

3. Hardening the surface of the slurry by activating a polymerization reaction or in some cases using the heat from another part of the process.

4. Hardening the cast material paste using a drying process such as one involving Infra-Red irradiation.

5. Heating to evaporate the binding materials, say solvents or water

The process then continues by printing the next mold layer 14.

The second mold layer may be printed on the surface of the previously cast paste material and may also be built over mold material from the previous layer.

The next stage is to fill the second mold layer, in a similar manner to that carried out for the first layer—16. Solidifying 24 may also be provided as needed.

For each additional layer needed in the product, the stages of hardening, printing and filling are repeated—18.

The hardened casting material paste in the shape of the final product or product part, is now embedded in the Sub Molds.

The final part may now be stabilized 25. While stopping the shear forces, the slurry or paste may start gelling and hardening, thus developing green strength to the cast material and/or activating hardening agents to impart green strength. Green strength is the mechanical strength which may be imparted to a compacted powder in order for the powder to withstand mechanical operations to which it is subjected before sintering, without damaging its fine details and sharp edges.

If the gelcast procedure is conducted then the final green strength is developed by thermal polymerization. Thermal polymerization may be carried out at an elevated temperature that is higher than the hardened slurry freeze point and lower than the mold material melting point, and under suitable conditions that allow such a temperature to be selected.

The mold material may then be removed—26. Removal may involve heating the product and mold up to the melting point of the mold so that the mold material liquidizes and can be collected for re-use. Alternatively the mold may be removed by chemical dissolution.

In all mold and sub mold parts production a sink for collecting melted mold material, such as mineral wax, for reuse may be provided.

Once the mold has been removed then the sacrificial materials of the paste are removed—27, for example by evaporating and/or decomposing the sacrificial materials, such as carrier liquids and organic additives, by controllably heating to the optimal temp.

After the sacrificial materials are removed, the powder of the active material may be fused into solid form. A thermal treatment—box 27—such as sintering, may be applied to obtain the desired final properties for the product. As mentioned above, exemplary temperatures between 400° C. and 1800° C. may be used, and in particular temperatures exceeding 500° C.

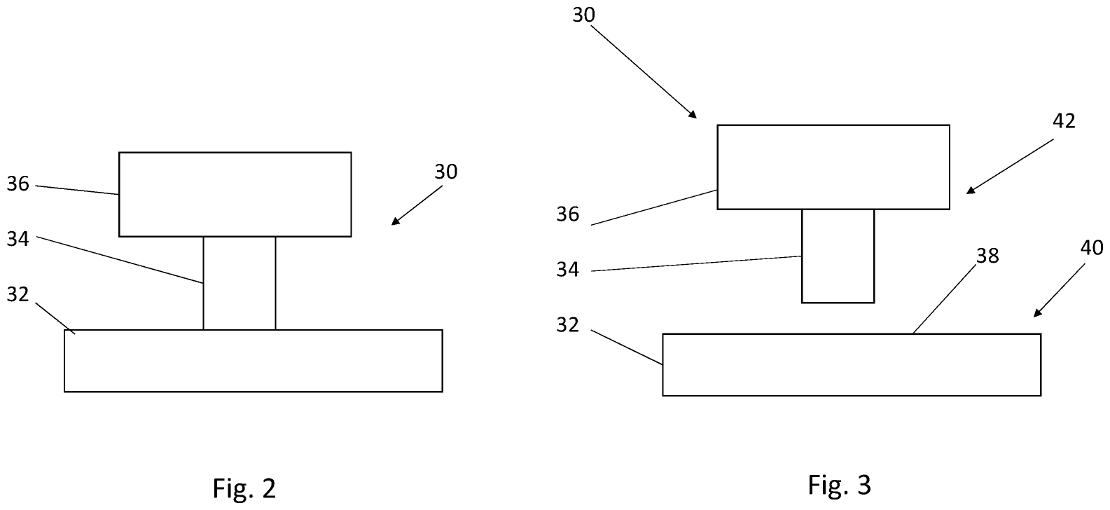

Reference is now made to FIG. 2, which is as simplified diagram illustrating a blueprint 30 for a product that it is desired to manufacture. The product has lower ring 32, middle ring 34 and upper ring 36, of which the lower ring has a large radius, the middle ring has a small radius and the upper ring has an intermediate radius.

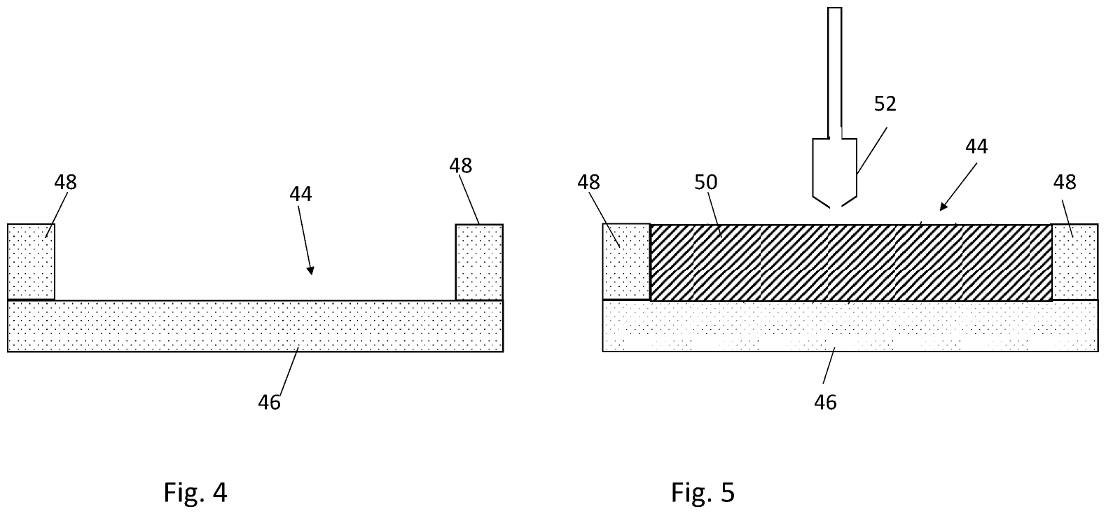

Reference is now made to FIG. 3, which illustrates one way to make the product 30. The product may be decomposed into layers, for each layer to be manufactured separately using the procedure outlined in FIGS. 1A-B. One possibility is to choose a fixed layer thickness and make the necessary number of layers of the fixed thickness, but in order to do so, the upper boundary 38 of lower ring 32 should fall exactly at a layer boundary, thus, layer thickness becomes the Z axis resolution providing a constraint as to the part dimension in the Z axis.

Another possibility is to manufacture each ring, 32, 34 and 36 as a separate layer, but then a support structure may be needed for the mold for the third layer, which would otherwise be suspended in mid-air.

In the current example, ring 32 is manufactured as a single first layer 40 and the two rings 34 and 36 are manufactured together as a single second layer 42.

Referring now to FIG. 4 and a mold 44 is 3D printed for the lower ring part 32. The mold consists of a floor 46 and an enclosing rim 48.

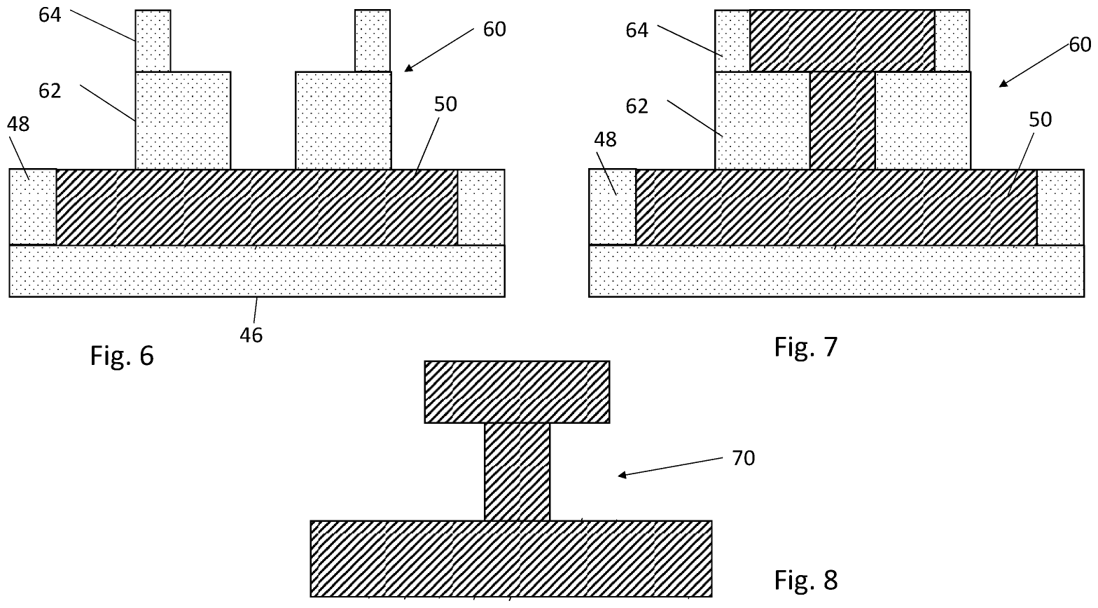

FIG. 5 illustrates the mold 44 of FIG. 4 filled with a cast material 50. The cast material, which may be a combination binders and additives, perhaps a wax and a metal or ceramic powder, fills the mold over the floor 46 within the rim 48. The cast material may be poured from nozzle 52 which may be part of a specialized device according to the present embodiments, as will be discussed in greater detail below.

Reference is now made to FIG. 6, which illustrates the printing of the second layer according to the example of FIG. 2. A single mold part 60 is printed having a single outer radius which exceeds the radius of the upper ring 36. Internally a lower part 62 of mold 60 has a radius equal to that of intermediate ring 34, and upper part 64 of mold 60 has a radius equal to that of upper ring 36. The mold part 60 sits on the surface created by pouring of the cast layer 50, so that the existing surface of the product provides support and no additional support structure is needed. As mentioned above, in one embodiment, the viscosity of the cast layer may be enough to support the new mold part 60, or in an alternative embodiment, the first layer may harden first before placing the new mold part.

Referring now to FIG. 7, and the upper mold part 60 may be filled using more of the same cast material as was used for the lower part, thus to form the upper and intermediate rings of the product. Alternatively different cast materials may be used for different layers.

The mold and cast combination may be heated or debound or sintered to remove the mold and wax, to remove the binders and to fuse the powder in the cast material. Finally the product 70 emerges from the cast as shown in FIG. 8 after the wax is melted.

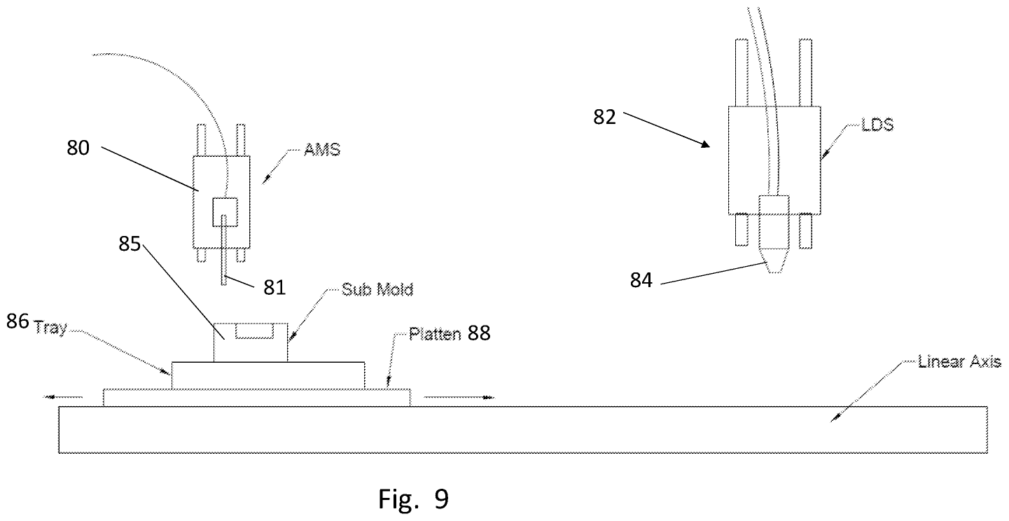

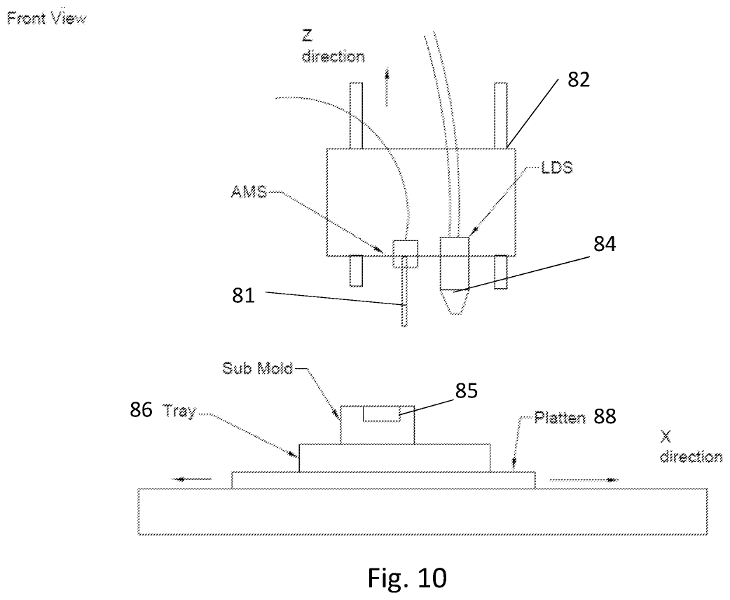

Reference is now made to FIG. 9, which shows parts of a 3D printing and filling device for printing a mold and filling the mold with a casting material. An extruder assembly 80 has a nozzle 81 with a nozzle size suitable for printing the mold or mold parts as discussed above using a first mold material. One printing nozzle 81 is shown for simplicity but any suitable number may be provided. The extruder assembly 80 may be a standard 3D extruder assembly which may for example be able to move with three degrees of freedom. More specifically, three degrees of freedom may be provided for relative motion between the tray and the applicator, and most FDM printers have an XY table and a Z axis for the extruder. The extruder assemblies may have any desired number of nozzles.

A cast material applicator 82, may consist of a single pouring nozzle 84 and is provided in order to pour the casting material into the mold once the mold has been formed. Nozzle 84 is sized to efficiently fill the mold with cast material so that the cast material is not applied by the same technology as the mold material. Thus a relatively rough technology is used for the cast material and a relatively fine technology for the mold. The mold defines the geometry and the cast provides the properties of the part. The pouring nozzle may be provided to achieve the required filling throughput, minimal diameter, etc.

Multiple nozzles may be provided to accelerate filling speed and still allow accurate filling.

In one embodiment, where the cast material is in a paste form, the paste may be poured inside or outside the cavity and then the cavity may be filled out by moving a squeegee along the cavity borders.

In greater detail, the device may comprise two main sub systems.

1. An Additive Manufacturing System (AMS) 80, which may be based on FDM, Inkjet, and other well-known methods and which make the Sub-Molds. The system may involve at least three degrees of freedom in refer to the building tray. According to an embodiment of this invention, the Sub Mold may be made of a mineral wax or like material.

2. A Liquid Dispensing System (LDS) on which pouring system 82 is based, in which the cast material for making the part is cast or poured into the mold. Part material may be any liquid suspension or paste of metal, ceramic or other material as discussed above.

The cast material in liquid form is dispensed in a controlled manner according to a pre-defined value, for example, depending on the Sub Mold volume to be filled.

Positioning of the pouring system 82 is also determined according to preferred filling locations in relation to the Sub Mold. The pouring system may typically have at least two degrees of freedom relative to the building tray. In some cases a third degree of freedom may be provided.

A vibrating surface may be provided to vibrate the mold and ensure that the material that is poured is evenly distributed and leveled within the mold. A hardening unit such as Infra-Red Lamp or Hot Air unit may be provided to heat the mold and cast material and ensure that the material is hardened sufficiently.

A first step before producing the part comprises preparing digital manufacturing files to reflect the blueprint. The part is divided, or sliced, into Sub Parts for the separate layers. For each Sub Part, a Sub Mold file is prepared.

Then each Sub Mold file is sent to the additive manufacturing system (AMS) for printing. The Sub mold is built on the Device Tray. The tray is then moved to the LDS location, and material is dispensed into the Sub Mold to fill the space defined within. Once the process is accomplished, the device tray returns to the ADS location where the next Sub Mold file is sent. The new Sub Mold is built on top of the layer just poured and the procedure repeats layer by layer until all Sub Parts are made.

There are a number of ways of producing Sub files. Each file is required to be “legal”, meaning that a Sub Mold can be physically produced by the relevant additive manufacturing method used in the device, and that a physical Sub part can be made by inserting casting material into the mold. Non legal files may for example comprise mold shapes that are liable to collapse.

In an embodiment, Sub files may be produced according to a chosen Z resolution of the device, meaning that a predetermined layer height is selected. For example, if the chosen resolution of the device is 0.2 mm, then the product may be sliced by the software into separate 0.2 mm sub part files, and Sub parts will be prepared accordingly. The thickness may be modified to according to the part geometry quality requirement.

In another embodiment, Sub Parts may be defined according to the maximal Sub Mold depth that can be properly filled with cast material.

In addition, the sub mold files may be scaled according to an estimated shrinkage of the Part during the Thermal processes.

The assembly of Sub Molds and Sub Parts is then taken to a thermal processing unit. According to an embodiment, thermal processing may include the following steps:

1. Increasing the temperature to melt the Wax.

2. Immersion in solvent or gas to dissolve or leach out part of the binder and or increasing the temperature to perform debinding.

3. Increasing the temperature again to perform sintering.

4. Adding thermal processes as required according to material and quality requirements. For example, Hot Isostatic Pressing can improve density of the part. Aluminum parts can be tempered and aged and so on.

As an alternative to the above and the use of melting to remove the wax, the wax may be removed using a solvent. As a further alternative, a combination of melting and using a solvent may be used.

As shown, the mold part 85 is printed on a tray 86 which in turn sits on moving platen 88. The platen moves on linear axis 90 between the 3D printing head 80 and the pouring nozzle 84. For a single part, the platen may move between the two positions once for every layer. As an alternative to a linear axis the platen may be rotary and may rotate between the two positions.

In a further embodiment, multiple stations may be provided on the path of the platen, so that there may be several printing positions and several filling positions, and multiple parts may be printed in parallel.

In a further embodiment, multiple stations may be provided on the path of the platen, so that there may be several added processes positions such as an IR station, polishing station etc.

The pouring nozzle 84 may be removable, and in embodiments may be exchanged with other nozzles of different sizes so that products of different scales may all be filled efficiently using suitable filling rates.

Reference is now made to FIG. 10, which is a simplified diagram showing a variation of the device of FIG. 9, in which the printing head 80 and the pouring nozzle 82 are combined into a single dual purpose operating unit 89 carrying both printing nozzles 81 and pouring nozzles 84, but which do not necessarily operate simultaneously.

The unit 89 may have three degrees of freedom or more with reference to the tray, to print the mold and then subsequently fill the mold.

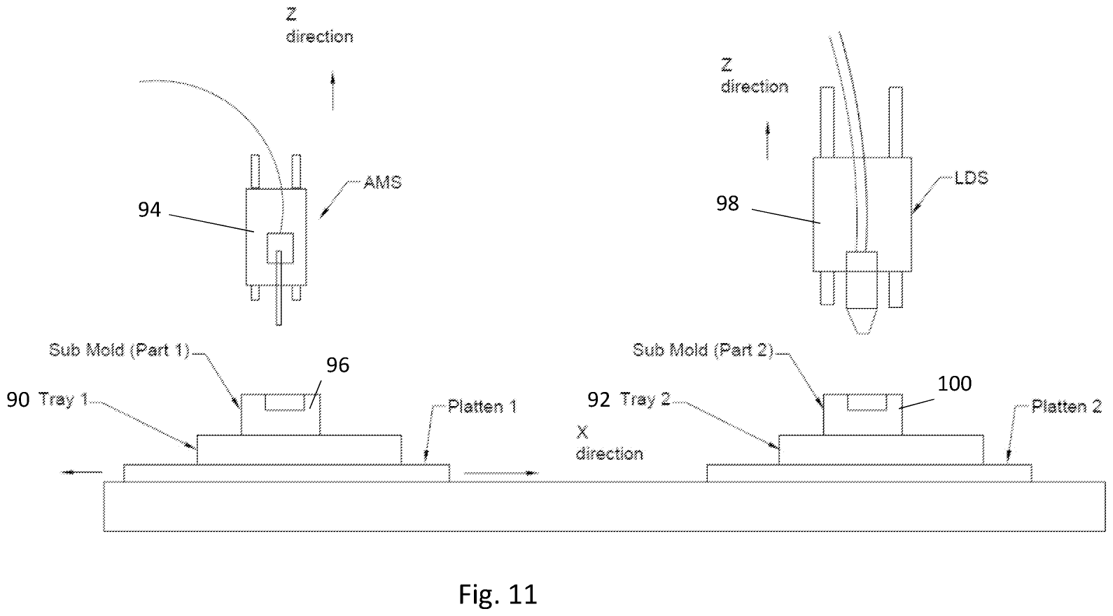

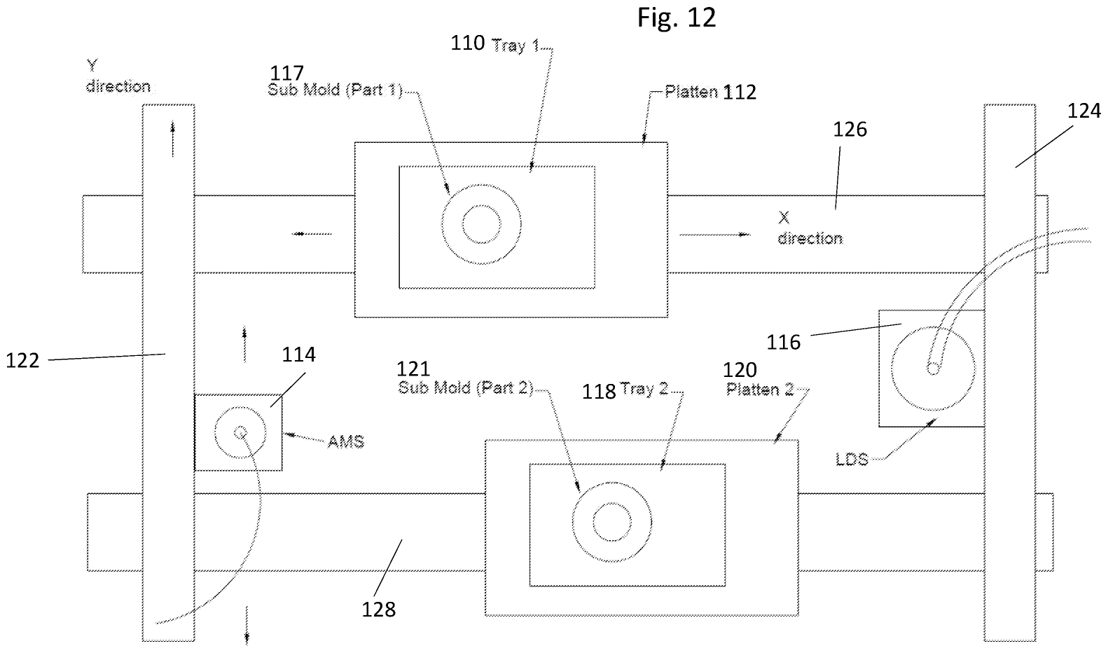

FIG. 11 and FIG. 12 are a front view and a top view respectively of a variation of the device of FIG. 9 having a printing station and a pouring station and two platens, each on a separate track. FIG. 11 is a simplified schematic diagram showing two trays, 90 and 92, each in position under one of the nozzles. Tray 90 is under printing head 94 which prints mold part 96. At the same time, tray 92 is under pouring unit 98, which pours casting material into mold part 100. Tray 92 may previously have been under printing head 94, to print the mold 100. Thus greater utilization is made of the printing machine by filling one mold while printing another.

In FIG. 12, First tray 110 travels on first platen 112 between the printing head 114 and the pouring unit 116, carrying mold part 117. Likewise second tray 118 travels on second platen 120 between the printing head 114 and the pouring unit 116, carrying mold part 121. The trays and platens travel in a first axis referred to herein as the x direction. The printing head 114 and the pouring unit 116 travel between the two platens in second axis which may be perpendicular or substantially perpendicular to the travel direction of the platens. The direction of travel of the printing and pouring units is indicated herein as the y direction. Bridges 122 and 124 may carry the head 114 and pouring unit 116 respectively. Likewise rails or tracks 126 and 128 may carry the platens 112 and 120. The printing head 114 typically has three degrees of freedom relative to the trays and applicators, and the same may apply to all embodiments herein.

In the embodiment of FIG. 12, each platen moves from mold printing position to pouring position and the printing heads and pouring units move from side to side, so that each side can be printed and poured sequentially, allowing for manufacture of two parts in parallel with high utilization of the print heads.

In an embodiment, the platens may be fixed, and the heads may move in the x direction. Either the heads or the platens may move in the y direction.

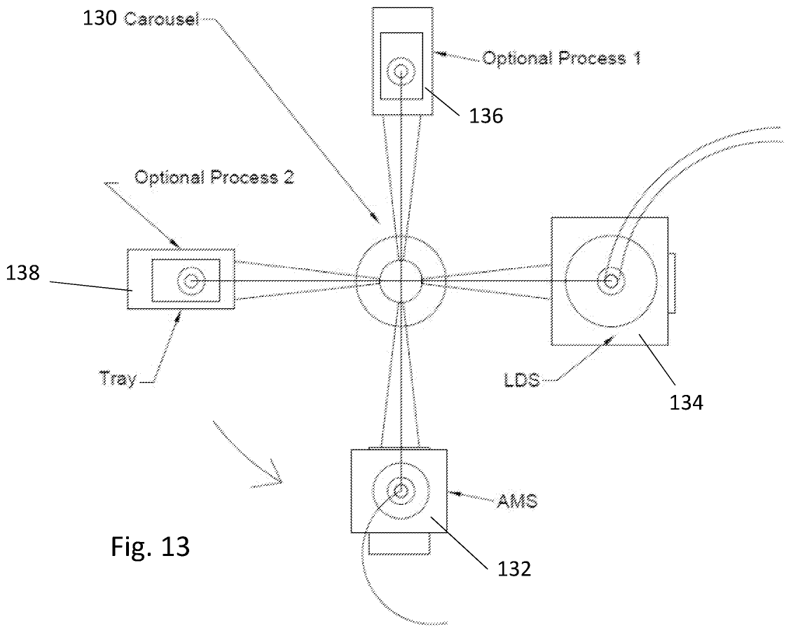

Reference is now made to FIG. 13, which illustrates an embodiment of the printing and pouring device based on a carousel 130 having four stations 132, 134, 136 and 138. The carousel rotates and each tray reaches station 132 for mold part printing, and station 134 for pouring. It is noted that during the processes themselves, the parts are stationary. The carousel may rotate over the angle between one station and the next station between each process. The two remaining stations 136 and 138 are labeled for optional processes. One possibility is that they may be provided with second printing head and pouring unit, to double capacity. Another possibility is that station 136 may include a finishing unit to finish the surface poured in stage 134, and station 138 may provide heating or Sintering is generally not included in the carousel stations as it takes hours, in vacuum at high temperatures.

Other uses of the optional stations may be contemplated and the carousel is not limited to four stations. Thus, stations may be added for various complementary processes that can be done in parallel, such as UV curing, IR thermal hardening, Hot air drying, Microwave drying, cooling, flattening or polishing or finishing and the like.

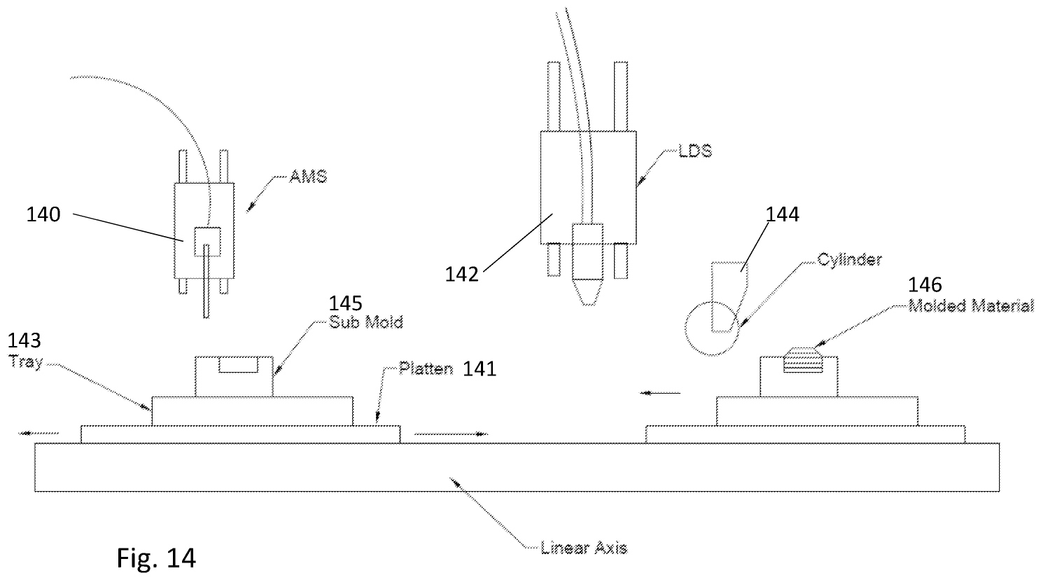

Reference is now made to FIG. 14, which shows a linear embodiment having a third station or process location. The platen 141 or platens carrying tray 143 and mold 145 move between a first position under printing head 140, a second position under pouring unit 142 and a third position under cylinder 144. The cylinder may smooth the cast material 146 following pouring. As will be recalled, the cast material may be of high viscosity and thus may tend to heap rather than find its own level as a lower viscosity material might be expected to do. Alternatively, the mold may deliberately be filled to a certain margin above the top of the mold as described elsewhere herein. Thus smoothing may be required before the next level can be started, or in order to finish the product or part. The cylinder may be used to flatten the mold and/or the filling of the mold, namely the cast material. In order to carry out flattening, the cylinder may be heated to a temperature in an exemplary range of 60-140° C.

It will be appreciated that the finishing station may be incorporated into embodiments using a carousel as well as into linear embodiments.

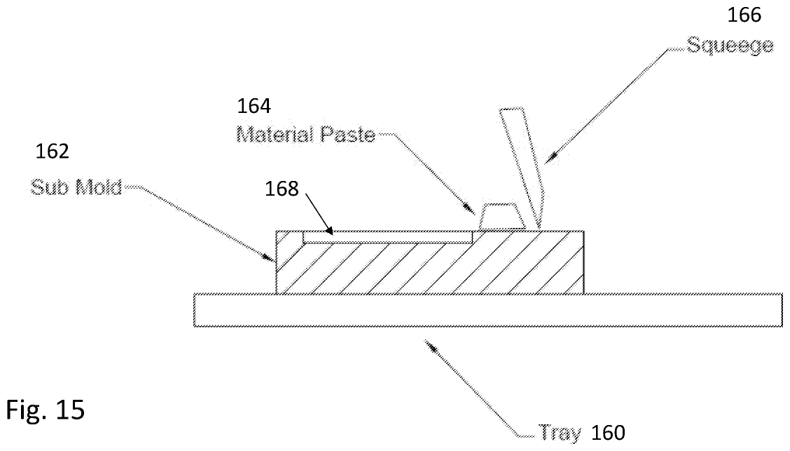

Reference is now made to FIG. 15, which illustrates another embodiment Tray 160 carries mold part or sub-mold 162 and a lump of paste 164 is provided to fill the mold. Squeegee 166 wipes the paste across the top of the mold, pushing it into space 168 in the mold and thus filling the mold and finishing the surface at the same time. As an alternative to a squeegee, a blade may be used.

The squeegee may be incorporated as an extra station together with a pouring nozzle, so that the use of pouring may get the paste into the space and then the squeegee may push the paste to fill out the space.

Paste dispensing may be used to provide the lump 164, say using paste dispensing nozzles. The nozzles may dispense the material alongside where it is needed and then the squeegee 166 may push the paste into the hollow in the mold and smooth the layer into position. Alternatively, the paste may be dispensed directly into the hollow, say using a row of dispensers, moving like a print head over the hollow in the mold, with the blade smoothing out the layer afterwards.

The row of dispensers may be provided at any desired resolution. The dispenser may be moved at an angle relative to blade motion or to table motion.

As shown in FIG. 15, the squeegee or blade may be pressed against the mold surface.

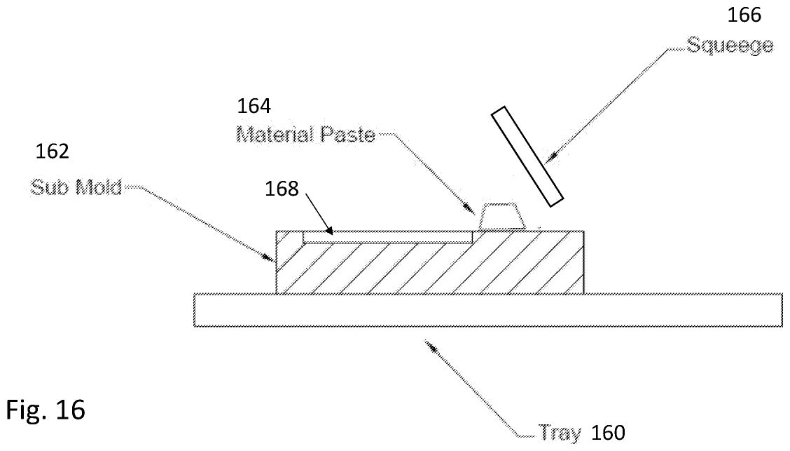

Reference is now made to FIG. 16 which is the same as FIG. 15 except that the squeegee or blade is spaced from the mold surface, say by between 1 and 100 microns to allow non contact filling of the mold. As in FIG. 15, tray 160 carries mold part or sub-mold 162 and a lump of paste 164 is provided to fill the mold. Squeegee 166 wipes the paste across the top of the mold, pushing it into space 168 in the mold and thus filling the mold and finishing the surface at the same time. Due to the space between the squeegee and the mold, a thin coating of paste may extend over the upper part of the mold surface.

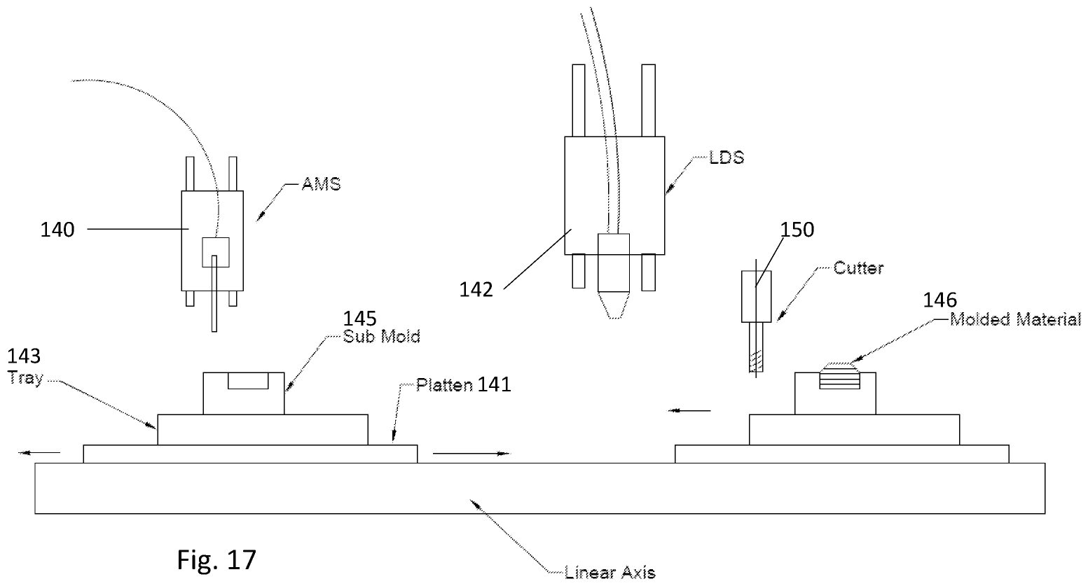

Reference is now made to FIG. 17, which shows an alternative linear embodiment also having a third station. The platen 141 or platens carrying tray 143 and mold 145 move between a first position under printing head 140, a second position under pouring unit 142 and a third position under polisher or cutter 150. The polisher cuts the excess of the cast material 146 following pouring and/or molding.

It will be appreciated that the polisher may be incorporated into embodiments using a carousel. The polisher 150 may be a machining tool such as a CNC tool, for example a fly cutter, that passes over the Sub Mold and polishes the Sub Part after the casting material has been poured and has hardened at a predetermined height, for example, 0.05 mm beyond the Sub Mold upper edge.

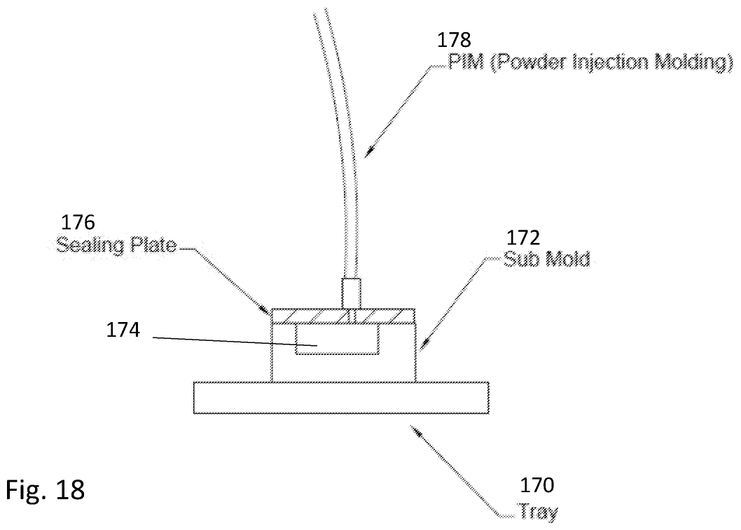

Reference is now made to FIG. 18, which illustrates a further alternative for filling a mold. Tray 170 carries sub-mold or part mold 172 which contains space 174 to be filled. Sealing plate 176 is sealed over the mold and includes pipe 178 for injection molding into the space. In particular, injection may use powder injection molding (PIM). The powder may be powder metallurgy (PM) powder, for example metal injection molding (MIM) powder. The powder may be a mix of large and small particles, both for the embodiment of FIG. 17 and for the other embodiments described herein.

Injection molding may be provided as an additional station, on either the linear or the carousel embodiments, or may be the principle station for filling the mold.

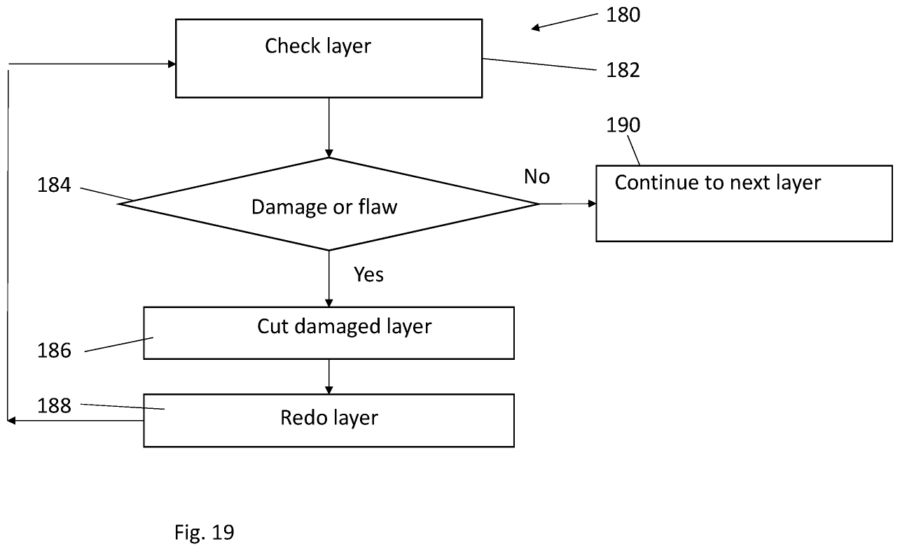

Reference is now made to FIG. 19, which is a simplified flow diagram showing a self-testing procedure 180. In procedure 180 the last placed layer is checked 182. In general the check may involve testing for smoothness, for example by imaging using a diagnostic camera. If a damage or flaw is detected in decision box 184 then the damaged layer is cut away 186 and a new layer is provided 188. If no such damage or flaw is detected then the process continues 190 to the next layer. The self-testing procedure is applicable to all the embodiments discussed herein, including those using nozzles and those involving spreading of paste.

The processes of any of the above embodiments may be carried out using an inert environment, say filled with nitrogen, argon or even in vacuum. This may help with highly oxidative materials.

It is expected that during the life of a patent maturing from this application many relevant molding, 3D printing and casting technologies will be developed and the scopes of the corresponding terms are intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the present description is to be read as if such combinations are explicitly set forth herein. Conversely, various features of the invention, which are, for brevity, described in the context of a single embodiment, may also be provided separately or in any suitable subcombination or as suitable in any other described embodiment of the invention and the present description is to be read as if such combinations are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. Method of manufacturing a molded layered product comprising:
carrying out 3D printing of a first mold to define one layer of said product;
filling said 3D printed first mold with a cast material, thereby forming a first layer;
carrying out 3D printing of a second mold on top of said first layer to define a second layer; and
filling said 3D printed second mold, over said first layer, with a cast material; thereby to form a molded layered product.

2. The method of claim 1, further comprising finishing said first layer after forming and prior to printing said second mold; thereby to form said second layer on the finished surface of said first layer.

3. The method of claim 1, wherein the molds are printed using a mold printing material.

4. The method of claim 3, wherein the mold printing material has a melting point which is lower than a melting point of said cast material.

5. The method of claim 1, wherein the cast material comprises one member of a first group consisting of wax, binders, hardening materials, a dispersing agent, an antifoam agent, a monomer, an oligomer, an initiator, an activator, a stabilizer, a debinding control additive, and a sintering controlling agent and one member of a second group consisting of a ceramic and a metal.

6. The method of claim 1, wherein the mold cast material comprises a slip material, or a gelcast material or a paste material.

7. The method of claim 6, wherein the mold printing material comprises a viscosity which is higher than a viscosity of the cast material.

8. The method of claim 6, wherein the slip or gelcast or paste is water based or organic solvent based.

9. The method of claim 1, wherein the cast material comprises a hydrophilic or hydrophobic component.

10. The method of claim 1, wherein said filling comprising pouring said cast material into said mold.

11-13. (canceled)

14. The method of claim 1, wherein said filling comprises using a squeegee pressed against the mold to spread said cast material into said mold, or wherein said filling comprising using a blade spaced from the mold surface to spread said cast material into said mold.

15. The method of claim 1, comprising using at least two different cast materials in different layers.

16. The method of claim 1, wherein said cast material comprises at least two different constituent materials or at least two different sized particles.

17. The method of claim 1, comprising removing said mold after casting using one member of the group comprising: heating, dissolving and a combination of heating and dissolving.

18-22. (canceled)

23. The method of claim 1, when carried out using a 3D printing device for printing a mold and filling the mold, the device comprising:
a nozzle, for 3D printing the mold using a mold material; and
a squeegee for pasting filling material to fill the mold.

24. The method of claim 1, when carried out using a 3D printing device for printing a mold and filling the mold, the device comprising:
a nozzle, for 3D printing the mold using a mold material;
a sealing cap for sealing the mold; and
an injection molding unit for injecting filling material to fill the mold.

25. A method of manufacturing a layered molded product, comprising:
preparing a plan of said layered molded product;
slicing said plan into a plurality of layers;
for each layer planning a mold;
for each layer in succession, 3D printing a respectively planned mold; and
for each layer in succession, after forming said respective 3D printed mold, pouring a cast material into said 3D printed mold to form said respective layer; and
3D printing successive layer molds on respectively following layers.

26. The method of claim 25, further comprising hardening each layer prior to print a successive layer mold thereon, or comprising polishing respective layers prior to forming a subsequent layer thereon.

27. (canceled)

28. The method of claim 25, wherein said cast material is selected to have rheological properties to flow and fill the mold and to hold to an inner surface of said mold.

29. The method of claim 25, comprising using heat to stabilize said product after all layers thereof have been formed.

30. (canceled)

31. The method of claim 25, comprising heating or using a solvent to remove sacrificial material from said cast material.

32. The method of claim 25, wherein the cast material comprises a powder, the method comprising applying thermal treatment to sinter said powder.

33. The method of claim 25, further comprising using a Hot Isostatic Pressing process (HIP) to increase a density of said cast material.

34. (canceled)
